(19) United States
(12) Patent Application Publication
(10) Pub. No.: US 2003/0164759 A1
(43) Pub. Date: Sep. 4, 2003

(54) System and method for tire pressure monitoring with optimal tire pressure indication during tire pressure adjustment

(75) Inventors: John S. Nantz, Brighton, MI (US); Qingfeng Tang, Novi, MI (US); Ronald O. King, Brownstown, MI (US); Riad Ghabra, Dearborn Heights, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI

(21) Appl. No.: 10/318,640

(22) Filed: Dec. 13, 2002

Related U.S. Application Data
(60) Provisional application No. 60/360,762, filed on Mar. 1, 2002.

(51) Int. Cl. B60C 23/02

(52) U.S. Cl. 340/442

(57) ABSTRACT

A system and method for remote monitoring of tire pressure provide an indication of optimal tire pressure when a tire inflation valve is actuated. A tire monitor mounted a tire includes sensors for sensing tire pressure and temperature, and a transmitter for transmitting wireless tire information signals having tire pressure and tire temperature data. A controller mounted on board the vehicle determines an optimal pressure for the tire based on the temperature data and vehicle load information. The controller generates a control signal for use in providing an audible and/or visual indication during tire pressure adjustment when the sensed tire pressure represented by the tire pressure data is substantially equal to the determined optimal tire pressure.

### CROSS REFERENCE TO RELATED APPLICATION

This application claims the benefit of U.S. provisional application Serial No. 60/360,762, filed Mar. 1, 2002.

### BACKGROUND OF THE INVENTION

1. Field of the Invention

The present invention relates to remote vehicle tire pressure monitoring where an indication of optimal tire pressure is provided to a user during tire pressure adjustment, such as during inflation.

2. Background

It is known in the automotive industry to provide for remote monitoring of vehicle tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver located on-board the vehicle. The tire pressure information delivered to the receiver by the RF signals from the transmitters is subsequently conveyed to a vehicle operator or occupant, typically in the form of a display inside the vehicle.

It is also known that optimal tire pressure is based on tire temperature and vehicle loading conditions. However, pressure gauges used during adjustments to tire pressure, such as during inflation, do not account for such parameters. As a result, using such gauges, a vehicle user may adjust the pressure of a tire to a recommended value that may not be the optimal pressure for the tire based on the current tire temperature and vehicle load.

Thus, there exists a need for an improved tire pressure monitoring system and method which would overcome such a problem. Such a system and method would determine an optimal tire pressure based on tire temperature and vehicle load, and would provide an indication to a vehicle user during tire pressure adjustment when the sensed tire pressure reaches the determined optimal pressure. Such an indication of optimal pressure would preferably be audible, such as sounding a vehicle horn, and/or visual, such as flashing a vehicle light.

### DISCLOSURE OF THE INVENTION

Accordingly, the present invention provides an improved system and method for remote vehicle tire pressure monitoring.

According to the present invention, then, in a vehicle having a plurality of tires, a system is provided for remote monitoring of tire pressure. The system comprises a tire monitor for mounting in the tire, the monitor comprising a pressure sensor for sensing tire pressure, a temperature sensor for sensing tire temperature, and a transmitter for transmitting wireless tire information signals comprising tire pressure and tire temperature data. The system further comprises a controller for mounting on board the vehicle, the controller for determining an optimal pressure for the tire based on the temperature data and vehicle load information. The controller generates a control signal for use in providing an audible indication during tire pressure adjustment when the sensed tire pressure represented by the tire pressure data is substantially equal to the determined optimal tire pressure.

According to an alternative embodiment of the present invention, a system is also provided for remote monitoring of tire pressure in a vehicle having a plurality of tires. The system comprises a tire monitor for mounting in the tire, the monitor comprising a pressure sensor for sensing tire pressure, a temperature sensor for sensing tire temperature, and a transmitter for transmitting wireless tire information signals comprising tire pressure and tire temperature data. The system further comprises a controller for mounting on board the vehicle, the controller for determining an optimal pressure for the tire based on the temperature data and vehicle load information. The controller generates a control signal for use in providing a visual indication during tire pressure adjustment when the sensed tire pressure represented by the tire pressure data is substantially equal to the determined optimal tire pressure.

Still further according to the present invention, in a vehicle having a plurality of tires, a method is provided for remote monitoring of tire pressure. The method comprises sensing a pressure and a temperature of a tire, and transmitting wireless tire information signals comprising tire pressure and tire temperature data representing the sensed pressure and temperature. The method further comprises determining an optimal pressure for the tire based on the temperature data and vehicle load information, and providing an indication during tire pressure adjustment when the sensed tire pressure represented by the tire pressure data is substantially equal to the determined optimal tire pressure.

The following detailed description and accompanying drawings set forth preferred embodiments of the present invention.

### BRIEF DESCRIPTION OF DRAWINGS

FIG. 1 is a simplified, representative block diagram of a tire pressure monitoring system according to the present invention; and

FIG. 2 is a simplified, representative flowchart of a tire pressure monitoring method according to the present invention.

### DETAILED DESCRIPTION OF THE PREFERRED EMBODIMENT(S)

Referring to the Figures, preferred embodiments of the present invention will now be described. As previously noted, it is known in the automotive industry to provide for remote monitoring of vehicle tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver located on-board the vehicle. The tire pressure information delivered to the receiver by the RF signals from the transmitters is subsequently conveyed to a vehicle operator or occupant, typically in the form of a display inside the vehicle.

As also noted above, it is further known that optimal tire pressure is based on tire temperature and vehicle loading conditions. However, pressure gauges used during adjustments to tire pressure, such as during inflation, do not account for such parameters. As a result, using such gauges, a vehicle user may adjust the pressure of a tire to a recommended value that may not be the optimal pressure for the tire based on the current tire temperature and vehicle load.

Thus, as previously noted, there exists a need for an improved tire pressure monitoring system and method which would overcome such a problem. Such a system and method would determine an optimal tire pressure based on tire temperature and vehicle load, and would provide an indication to a vehicle user during tire pressure adjustment when the sensed tire pressure reaches the determined optimal pressure. Such an indication of optimal pressure would preferably be audible, such as sounding a vehicle horn, and/or visual, such as flashing a vehicle light.

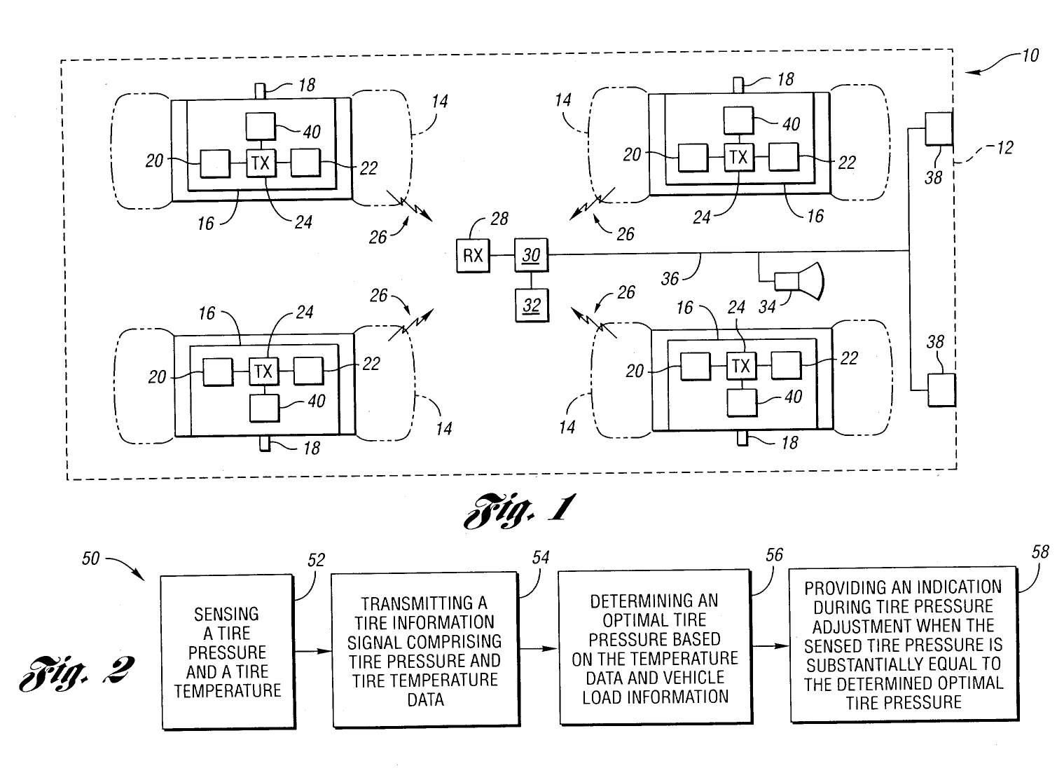

Referring now to FIG. 1, a simplified, representative block diagram of an embodiment of the system of the present invention for remote vehicle tire pressure monitoring is shown, denoted generally by reference numeral 10. As seen therein, the system (10) is designed for use in a vehicle (12) having a plurality of tires (14). It should be noted that while the present invention is described herein for use in an automotive vehicle having four tires, such an environment is exemplary only. That is, the present invention is suitable for use in any type of vehicle having any number of tires.

The system (10) preferably includes a plurality of tire monitors (16). Each tire monitor (16) is provided for mounting in one of the plurality of tires (14). In that regard, each tire monitor (16) is preferably located inside the tire (14) adjacent the stem for tire inflation valve (18), although any mounting location known in the art may be used. Each tire monitor (16) preferably includes a pressure sensor (20) and a temperature sensor (22) for sensing the pressure and temperature, respectively, of the associated tire (14). It should be noted, however, that each tire monitor (16) may also be equipped to sense, determine and/or monitor any number of tire parameters in addition to pressure and temperature including, but not limited to, status (i.e., whether or not the tire is rotating) and/or speed, in any fashion well known to those of ordinary skill in the art.

Each tire monitor (16) also includes a transmitter (24) in communication with pressure and temperature sensors (20, 22) for transmitting wireless tire information signals (26). Tire information signals (26) preferably comprise pressure data and temperature data representative of the tire pressure and tire temperature sensed by pressure and temperature sensors (20, 22), respectively. Tire information signals (26) are preferably radio frequency (RF) signal, although other signal types known in the art could be employed. It should be noted that tire pressure data and tire temperature data may be transmitted together as part of a single tire information signal (26), or separately as part of multiple tire information signals (26). It should also be noted that transmitter (24) may also transmit, as part of or separate from tire information signal (26), a signal or signals representative of information concerning any of a number of other tire parameters such as status and/or speed as sensed, measured and/or determined by an appropriately equipped tire monitor (16).

Referring still to FIG. 1, the tire pressure monitoring system (10) of the present invention also includes a receiver (28) for mounting on-board the vehicle (12) for receiving the tire information signals (26) transmitted by transmitters (24). Receiver (28) comprises one or more antenna (not shown) to be located at one or more selected sites on the vehicle (12). As seen in FIG. 1, receiver (28) is provided in communication with a controller (30) mounted on-board vehicle (12). Controller (30) is for processing tire information signals (26) received by receiver (28) from transmitters (24) and for generating information signals (not shown) for use in conveying at least tire pressure information to a vehicle operator. It should be noted that receiver (28) may be part of controller (30), or receiver (28) and controller (30) may be combined in a single module. It should also be noted that information concerning other tire parameters, such as temperature, status and/or speed may also be conveyed to the vehicle operator.

In that regard, the system (10) may further comprise a display unit (32) for mounting inside the vehicle (12). Display unit (32) is provided in communication with controller (30) and is for use in conveying information, such as tire pressure, to a vehicle occupant (not shown). Display unit (32) may comprise an LED display or a lighted icon in a dashboard or console of vehicle (12), although audible means such as tones or speech may also be used to convey tire pressure information to a vehicle occupant. As noted above, information concerning other tire parameters, such as temperature, speed and/or status, may also be conveyed to a vehicle occupant via controller (30) and display (32). It should be noted that the information conveyed to the vehicle occupant may include a warning, which may also be audible, if tire pressure or other tire parameters, such as temperature, are outside recommended ranges.

Still referring to FIG. 1, controller (30) is also for determining an optimal pressure level for each of the plurality of tires (14) based on tire temperature information and vehicle loading conditions. In that regard, vehicle load information may be provided to controller in any fashion known in the art, such as by suitable sensors. Based on such load information and tire temperature data from tire information signals (26), controller (30) determines an optimal pressure value for each tire (14) in any fashion known in the art.

During an adjustment of the pressure of a tire (14) by a vehicle user, such as tire inflation or deflation, controller (30) compares such a determined optimal pressure to the sensed pressure for that tire (14), and provides feedback to the vehicle user when the sensed tire pressure is substantially equal to the optimal tire pressure. In that regard, a tire pressure adjustment operation may be indicated in any fashion known in the art, such as by a sensor (not shown) to sense whether the tire inflation valve (18) is open or closed. Alternatively, such adjustment may be indicated by the rate of change of the pressure of tire (14) as determined by controller (30) based on tire pressure data from tire information signals (26) when the tire (14) is stationary. In that regard, tire monitor (16) may be equipped with a rotation sensor (not shown) to indicate whether tire (14) is rotating.

More particularly, during such a pressure adjustment operation, the pressure of tire (14) is sensed by sensor (20), and transmitter (24) transmits a wireless tire information signal (26) including tire pressure data, in the fashion previously described. Tire information signal (26) is received by receiver (28), and provided to controller (30). Using the tire pressure data from tire information signal (26), controller (30) compares the sensed pressure of tire (14) to the optimal pressure for that tire (14) determined based on the vehicle load and the temperature of that tire (14), as indicated by a tire information signal (26) including tire temperature data.

When the optimal and sensed tire pressure levels are substantially equal, controller (30) preferably generates one or more control signals (not shown) for use in providing an audible and/or visual indication to the vehicle user. For example, such a control signal may be used in controlling a vehicle horn (34). In that regard, vehicle horn (34) may be controlled to activate or “chirp” one or more times, thereby providing the vehicle user with an audible indication that the pressure for tire (14) has reached the optimal level based on the current vehicle load and the temperature of the tire (14). Controller (30) may be provided in direct communication with vehicle horn (34) although, alternatively, controller (30) is preferably provided in communication with vehicle horn (34) via a vehicle bus (36).

Similarly, such a control signal may used in controlling one or more vehicle lights (38). In that regard, vehicle lights (38) are preferably the vehicle headlights, although parking lights, tail lights, other vehicle lights, or any combination of vehicle lights could be used. Vehicle lights (38) may be controlled to activate or “flash” one or more times, thereby providing the vehicle user with a visual indication that the pressure for tire (14) has reached the optimal level based on the current vehicle load and the temperature of the tire (14). Once again, controller (30) is preferably provided in communication with vehicle lights (38) via vehicle bus (36), but may be provided in communication with vehicle lights (38) directly. It should also be noted that such audible and visual indications may be used in combination to provide feedback to the vehicle user that the pressure for tire (14) has reached the optimal level based on the current vehicle load and the temperature of the tire (14).

Referring still to FIG. 1, it should be noted that each pressure sensor (20), temperature sensor (22) and/or transmitter (24) preferably has a unique identification code associated therewith. Such identification codes serve to particularly associate sensors (20, 22) and/or transmitters (24) with vehicle (12). Each transmitter (24) also preferably transmits such identification code for receipt by receiver (28) and for use by controller (30) in verifying that the tire information signals (26) received by receiver (28) are associated with the vehicle (12). Transmitters (24) may transmit the identification codes as part of tire information signal (26), or as a separate signal (not shown). Such an information code may also be used by controller (30) during a pressure adjustment operation for a tire (14) to verify that a received tire information signal (26) is associated with that tire (14).

It should also be noted that, as is well known in the art, each transmitter (24) is powered by a suitable battery (40) provided as part of tire monitor (16). To extend the operational life of battery (40), rather than transmit tire information signals (26) continuously, each transmitter (24) preferably transmits tire information signals (26) intermittently. In that regard, the particular period employed for such transmissions is not critical, and may be the same for each transmitter (24), or may differ from transmitter (24) to transmitter (24). Additionally, the period may be fixed, or may vary in any fashion, including specific or random periods. In any event, as noted above, periodic transmission of tire information signals (26) by transmitters (24) extends the operational life of battery (40).

In that regard, transmitters (24) may also transmit, as part of or separate from tire information signals (26), a signal (not shown) representing status information for the associated battery (40), including a low battery power status signal. Such battery status information may also be conveyed to a vehicle occupant via controller (30) and display (32). In such a fashion, a vehicle operator can have a battery (40) with low power replaced before such a battery (40) expires, thereby rendering the associated transmitter (24) inoperable.

Referring next to FIG. 2, a simplified, representative flowchart of an embodiment of a tire pressure monitoring method according to the present invention is shown, denoted generally by reference numeral 50. The method (50) is for remote monitoring of tire pressure in a vehicle having a plurality of tires. As seen in FIG. 2, the method comprises sensing (52) a pressure and a temperature of a tire, and transmitting (54) wireless tire information signals comprising tire pressure and tire temperature data representing the sensed pressure and temperature. The method (50) further comprises determining (56) an optimal pressure for the tire based on the temperature data and vehicle load information, and providing (58) an indication during tire pressure adjustment when the sensed tire pressure represented by the tire pressure data is substantially equal to the determined optimal tire pressure.

In that regard, as described in greater detail above in connection with FIG. 1, according to the method (50) of the present invention, the indication of optimal tire pressure preferably comprises at least one activation of a vehicle horn and/or vehicle light. It should again be noted that tire pressure data and tire temperature data may be transmitted together as part of a single tire information signal, or separately as part of multiple tire information signals.

It should also be noted that the simplified flowchart depicted in FIG. 2 is exemplary of the method (50) of the present invention. In that regard, the method (50) may be executed in sequences other than those shown in FIG. 2, including the execution of a subset of the steps or functions shown and/or the execution of one or more such steps or functions simultaneously.

From the foregoing description, it can be seen that the present invention provides an improved tire pressure monitoring system and method that determine an optimal tire pressure based on tire temperature and vehicle load, and provide an indication to a vehicle user during tire pressure adjustment when the sensed tire pressure reaches the determined optimal pressure. The improved system and method of the present invention preferably provide such an indication of optimal pressure with an audible signal, such as sounding a vehicle horn, and/or a visual signal, such as flashing a vehicle light.

While various embodiments of the invention have been illustrated and described, it is not intended that these embodiments illustrate and describe all possible forms of the present invention. Rather, the words used in the specification are words of description rather than limitation, and it is understood that various changes may be made without departing from the spirit and scope of the invention. Indeed, many alternatives, modifications, and variations will be apparent to those skilled in the art in light of the foregoing description, and the present invention is intended to embrace all such alternatives.

What is claimed is:

1. In a vehicle having a plurality of tires, a system for remote monitoring of tire pressure comprising:
a tire monitor for mounting in the tire, the monitor comprising a pressure sensor for sensing tire pressure, a temperature sensor for sensing tire temperature, and a transmitter for transmitting wireless tire information signals comprising tire pressure and tire temperature data; and
a controller for mounting on board the vehicle, the controller for determining an optimal pressure for the tire based on the temperature data and vehicle load information, wherein the controller generates a control signal for use in providing an audible indication during tire pressure adjustment when the sensed tire pressure represented by the tire pressure data is substantially equal to the determined optimal tire pressure.

2. The system of claim 1 wherein the control signal is for use in controlling a vehicle horn and the audible indication comprises at least one activation of the vehicle horn.

3. The system of claim 1 further comprising a receiver for mounting on the vehicle and to be provided in communication with the controller, the receiver for receiving the tire information signals.

4. The system of claim 3 wherein the controller and receiver together comprise a control unit, the control unit for mounting on the vehicle.

5. The system of claim 1 wherein a single tire information signal comprises tire pressure data and tire temperature data.

6. The system of claim 1 wherein the controller comprises a receiver for receiving the tire information signals.

7. The system of claim 1 wherein the controller is for use in controlling a vehicle light to provide a visual indication when the sensed tire pressure represented by the tire pressure data is substantially equal to the determined optimal tire pressure.

8. In a vehicle having a plurality of tires, a system for remote monitoring of tire pressure comprising:
a tire monitor for mounting in the tire, the monitor comprising a pressure sensor for sensing tire pressure, a temperature sensor for sensing tire temperature, and a transmitter for transmitting wireless tire information signals comprising tire pressure and tire temperature data; and
a controller for mounting on board the vehicle, the controller for determining an optimal pressure for the tire based on the temperature data and vehicle load information, wherein the controller generates a control signal for use in providing a visual indication during tire pressure adjustment when the sensed tire pressure represented by the tire pressure data is substantially equal to the determined optimal tire pressure.

9. The system of claim 8 wherein the control signal is for use in controlling a vehicle light and the visual indication comprises at least one activation of the vehicle light.

10. The system of claim 8 further comprising a receiver for mounting on the vehicle and to be provided in communication with the controller, the receiver for receiving the tire information signals.

11. The system of claim 10 wherein the controller and receiver together comprise a control unit, the control unit for mounting on the vehicle.

12. The system of claim 8 wherein a single tire information signal comprises tire pressure data and tire temperature data.

13. The system of claim 8 wherein the controller comprises a receiver for receiving the tire information signals.

14. The system of claim 8 wherein the controller is for use in controlling a vehicle horn for providing an audible indication when the sensed tire pressure represented by the tire pressure data is substantially equal to the determined optimal tire pressure.

15. In a vehicle having a plurality of tires, a method for remote monitoring of tire pressure comprising:
sensing a pressure and a temperature of a tire;
transmitting wireless tire information signals comprising tire pressure and tire temperature data representing the sensed pressure and temperature;
determining an optimal pressure for the tire based on the temperature data and vehicle load information; and
providing an indication during tire pressure adjustment when the sensed tire pressure represented by the tire pressure data is substantially equal to the determined optimal tire pressure.

16. The method of claim 15 wherein the indication comprises at least one activation of a vehicle horn.

17. The method of claim 15 wherein the indication comprises at least one activation of a vehicle light.

18. The method of claim 16 wherein the indication comprises at least one activation of a vehicle light.

19. The method of claim 15 wherein a single tire information signal comprises tire pressure data and tire temperature data.
